(19) United States
(12) Patent Application Publication
(10) Pub. No.: US 2007/0233565 A1
(43) Pub. Date: Oct. 4, 2007

(54) Online Advertising System and Method

(76) Inventors: Jeff Herzog, Scottsdale, AZ (US); Chris Chevalier, Phoenix, AZ (US); Narayanan Ramamrutham, Peoria, AZ (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/614,715

(22) Filed: Dec. 21, 2006

Related U.S. Application Data
(60) Provisional application No. 60/757,065, filed on Jan. 6, 2006.

(51) Int. Cl. G06Q 30/00; G06F 15/173

(52) U.S. Cl. 705/14; 709/224

(57) ABSTRACT

An online advertising system and method permits a business or individual to create an online advertisement, market the advertisement on the internet or another communications network, and track online activity associated with the advertisement. The advertising system may include a series of websites (referred to as “area code local sites”) that provide a marketing distribution channel or network. The area code local sites may be used to provide one of the marketing channels for publication of an online advertisement created using the advertising system.

### RELATED APPLICATIONS

This application claims priority to Provisional Application No. 60/757,065, filed Jan. 6, 2006 (titled ONLINE ADVERTISING SYSTEM AND METHOD by Jeff Herzog et al.), the contents of which are incorporated herein by reference in their entirety.

### BACKGROUND

1. Field

The present disclosure relates in general to advertising systems and methods, and more particularly to a method and system for online advertising.

2. General Background

Online advertising generally refers to advertising on the internet. Online advertising is a source of revenue for an increasing number of companies. For example, Google receives significant revenue from the placement of advertisements in search results generated for online users.

Online visitors to websites on the Internet may be directed to a company's website in several ways including, for example, paid-for advertisements that link to a merchant's website or links presented in the natural search results presented by a search engine (e.g., Yahoo!, MSN, or Google) in response to a visitor's language query.

Natural search optimization (NSO), or alternatively search engine optimization (SEO), is a set of approaches used to improve the ranking of a website in search engine listings (e.g., such as in Google search results). Typically, NSO has the goal of improving the visibility of a merchant or other company's website in natural search results. A merchant's desired visibility goal will vary depending on the type of web traffic the merchant is seeking. For example, a merchant may desire to target a specific population with certain needs or interests. Such a merchant typically attempts to optimize its website for keywords likely to be used by the desired potential customer in requesting a keyword search from a search engine.

Natural search results attract the majority of internet search click-throughs (e.g., up to 80%), depending on the applicable vertical market and the type of search. There are billions of web pages that exist on the internet; only a small percentage will appear on the first page of the natural search results. Those that do typically make the most qualified connection with the desired target audience for a merchant or company's website and outrank or have improved visibility as compared to their competition. NSO helps to ensure that web content achieves the maximum visibility for its most relevant keywords and phrases across the leading search engines. Natural search results appear as the main body of listings in major search engines, typically distinct from the advertising that is labeled as “paid,” “featured,” or “sponsored.” Search engines create natural results by crawling the web, sending “spiders” out to follow the billions of links on the internet and find new and updated pages.

NSO permits online content (e.g., Adobe PDF files, Flash files, news releases, or product descriptions) to be crawled, indexed, and ranked by leading search engines. An NSO service provider or agency typically provides strategic recommendations to ensure that spiders find and read optimized content for search visibility. By managing, analyzing, and reporting on the performance of a website's visibility and providing ongoing recommendations, the service provider typically enhances the quality and quantity of a business's online traffic.

Businesses that advertise typically desire information about the return on investment (ROI) that is achieved by the advertising. Working with an NSO agency helps to ensure that all web content on a website has been optimized for maximum exposure and ROI. The search engine landscape changes constantly, and competitors vie to attract the same visibility. Also, search engines regularly rework the factors and methods used to rank webpages. Further, businesses often change their business objectives and messaging (e.g., as a business evolves or product or service markets change). To account for the foregoing dynamic conditions, businesses often routinely update the NSO of their websites to reflect recent changes in the natural search engine results.

Many merchants or businesses (e.g., many small to medium enterprises or SMEs) do not yet have a web presence, but would benefit from online or internet marketing to increase consumer or other customer online inquiries, and foot traffic. Because of the often higher level of human involvement required in using a traditional NSO agency's services, SMEs are sometimes limited in the use of such traditional services.

In light of the above, it would be desirable to have an online advertising system and method that improves the ability of SMEs to use online advertising and NSO and the ability to routinely update the NSO to account for business and search engine changes.

### BRIEF DESCRIPTION OF THE DRAWINGS

For a more complete understanding of the present disclosure, reference is now made to the following figures, wherein like reference numbers refer to similar items throughout the figures:

FIG. 1 is a functional block diagram illustrating an architecture for an advertising system in accordance with one embodiment;

FIG. 2 is a functional block diagram illustrating an architecture for an area code local site coupled to an advertising system in accordance with one embodiment; and

FIG. 3 illustrates the functional operational flow of the advertising system of FIG. 1 from the user perspective of an advertiser.

The exemplification set out herein illustrates particular embodiments, and such exemplification is not intended to be construed as limiting in any manner.

### DETAILED DESCRIPTION OF THE DISCLOSURE

The following description and the drawings illustrate specific embodiments sufficiently to enable those skilled in the art to practice the system and method described. Other embodiments may incorporate structural, logical, process and other changes. Examples merely typify possible variations. Individual components and functions are optional unless explicitly required, and the sequence of operations may vary. Portions and features of some embodiments may be included in or substituted for those of others.

The elements that implement the various embodiments of the present system and method are described below, in some cases at an architectural level. Many elements may be configured using well-known structures. The functionality and processes herein are described in such a manner to enable one of ordinary skill in the art to implement the functionality and processes within the architecture.

The processing described below may be performed by a single platform or by a distributed processing platform. In addition, such processing and functionality can be implemented in the form of special purpose hardware or in the form of software or firmware being run by a general-purpose or network processor. Data handled in such processing or created as a result of such processing can be stored in any type of memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including existing memory technologies as well as hardware or circuit representations of such structures and of such data.

It should also be understood that the techniques of the present system and method might be implemented using a variety of technologies. For example, the methods described herein may be implemented in software running on a programmable microprocessor, or implemented in hardware utilizing either a combination of microprocessors or other specially designed application specific integrated circuits, programmable logic devices, or various combinations thereof. In particular, the methods described herein may be implemented by a series of computer-executable instructions residing on a storage medium such as a carrier wave, disk drive, or other computer-readable medium.

As used herein, the term “entity” refers to an individual, corporation, partnership, or other type of legal entity.

An online advertising system and method (sometimes referred to below as simply an “advertising system”) are described below. Briefly stated, in a first aspect the advertising system permits an entity to create an online advertisement (sometimes referred to herein as simply “ad”), market the advertisement on the internet or another communications network, and track online activity associated with the advertisement. Typically, the entity is a small to medium-sized business, but may be any entity desiring to do online advertising. The system may be largely or wholly automated, minimizing the need for advertisers to engage in a traditional agency relationship with the operator of the system.

For example, the advertising system may provide a web portal accessible by an entity desiring to provide an online advertisement (an “advertiser”) in which the advertiser creates one or more ads, selects a marketing strategy using the web portal, provides payment or funding for the selected strategy, and tracks the performance of the strategy. Providing the services through a portal is expected in many cases to reduce or eliminate the manual, NSO agency services traditionally provided to an advertiser implementing a new marketing strategy. The advertising system also may, for example, permit an advertiser to track ads containing specific offers through a self-service interface. One specific exemplary embodiment of the advertising system described herein is sometimes referred to as “internet crossing” and may be implemented through a web portal.

The ability to create an ad may be offered for a fee or free of charge to an advertiser. The cost to market the ad online may be, for example, based on a pay-for-performance model (e.g., with cost-per-click and/or cost-per-call cost bases) or on a fixed periodic basis (e.g., monthly, annually).

In a second aspect, the advertising system includes a series of websites (generally referred to herein as “area code local sites” or “area code local”) that provide a marketing distribution channel or network for online advertisements. For example, the area code local sites may be used to provide one of the marketing channels (i.e., posting of ads) for publication of the advertisement created using the first aspect of the advertising system described above.

Ads from an advertiser in a certain geographic region, such as a specific area code, may be included in the specific site corresponding to that area code. Accordingly, online customers searching, for example, for services provided in a city in that area code will have the URL for the specific ad desirably appear at a higher ranking (ideally, a first ranking) in a search engine's search results. The visibility (e.g., search engine ranking) that is achieved by an ad included in one or more area code local sites is usually expected to be greater than the visibility that would be achieved by the same ad if placed on a conventional website.

The area code local sites may be used, for example, to assist an advertiser in targeting specific geographical areas with a marketing campaign, and locally-targeted outlets for the campaign. Other marketing channels (online, other non-computer-network, and/or traditional marketing approaches) may be used in conjunction with the area code local sites and may have been selected by an advertiser as part of the marketing strategy established using the portal discussed above. An example of such other online marketing channels are sites affiliated with the operator or owner of the area code local sites (e.g., partner sites).

In addition to active outbound marketing of the ad, the advertiser would benefit from the automatic application of NSO techniques to the created ad. These benefits include the favorable positioning of the ad in natural search results on third-party search sites, such as Google, Yahoo!, and MSN.

The area code local sites may be implemented, for example, as a series of websites having uniform resource locators (URLs) including a telephone area code followed by the word “local”. An example of an URL for such a site would be www.212local.com. These sites may provide a search engine specifically targeted to a given area code. Note that other word choices or combinations could be selected for the series of URLs corresponding to the area code local sites.

In general, the area code local sites are a series of websites corresponding to local, and typically distinct, physical areas. In alternative embodiments of the advertising system the physical areas do not have to be area codes, but could correspond to other arbitrary demarcations of physical space. In general, this physical space would be that space in which persons or tangible materials move through or interact with in some physical manner.

The area code local sites are preferably processed using natural search optimization and/or other customization (e.g., customization for paid search) to increase the visibility of and user traffic to the area code local sites (e.g., as presented in search results to users of search engines). This optimization is an improvement over prior NSO approaches that focus solely on the optimization of a single web page for a product or service combined with a specific geographic region.

Advertisement Creation, Marketing and Tracking

1. Creation

Now discussing the advertising system in more detail, advertisers (which may be a customer or client of an NSO agency) may use a web portal provided by the advertising system to create advertisements including, for example, enhanced directory listings, pay-per-click, and pay-per-call ads for search engine submission, full HTML pages, or clickable coupons or other offers.

Ads may be created using an approach in which a template is presented to an advertiser. After the advertiser provides data to create an ad, the advertising system may automatically analyze the ad and/or add additional content to the ad to improve its marketing performance. The additional content may be invisible to the advertiser.

The created ads may be categorized using a hierarchy similar to, for example, prior art “Yellow Pages” advertisements.

The system may provide the advertiser with options to create ads optimized for multiple methods of delivery, such as the world wide web and mobile phones or computing devices.

2. Marketing

An advertiser may create and manage a marketing campaign, which may include keyword selection, the setting of an advertising budget (e.g., flat monthly rate and total campaign cost), the campaign duration, the designation of selected ads for inclusion in a given campaign, and the selection of one or more destinations or channels in which the ad(s) will run (e.g., Yahoo!, Google, or MSN).

The ads may be posted to area code local sites, as discussed below, and the ads may also be posted to partner sites. Channel partners may include, for example, online local directories, online newspapers, internet Yellow Pages, and internet service providers (ISPs).

A keyword generator may assist the advertiser in selecting appropriate keywords for marketing the new ad to search engines. A bid manager may assist advertisers in cost management in the funding of search engine and other forms of bid-based marketing. For example, advertisers may only be charged by the advertising system operator when consumers or other customers click on the advertiser's ad or call the phone number in the ad.

An existing keyword database (e.g., created from any prior ad creation and/or optimization) may be coupled to the advertising system. The keyword database may be used to maximize the return on keyword bids made by the bid manager module.

The ads created by the advertising system typically will reside on one or more servers controlled by the administrator of the advertising system. However, in some embodiments, the ads may reside partially or wholly on third-party servers.

3. Tracking

Results from the marketing campaign may be reported to the advertiser using the web portal. A reporting module may report, for example, performance of an ad on various search engines (and/or other distribution channels). The reporting module may track, for example, the following: (i) conversions from search engine ads to offers on the area code local network; (ii) leads for an advertiser's future direct marketing efforts by capturing information such as the name, email, and phone number of interested consumers through a coupon process; and (iii) the purchase latency for advertisers that have e-commerce capabilities.

The reporting of tracking information as described herein may aid in determining the effectiveness and return on investment of advertising. By defining the metrics that of interest to its business and monitoring them closely, an advertiser may gain additional marketing knowledge regarding its target audience.

Some of the performance indicators that may be reported to an advertiser include, for example, the following: keyword analysis, keyword ranking reports, paid vs. natural search comparisons, SKU tracking, path analysis, page analysis, comprehensive search engine comparison traffic data, and conversion breakdown.

The advertising system may also detect suspicious activity and provide one or more alerts to an advertiser when a marketing campaign specified through the advertiser portal appears to be a potential victim of click or other types of online fraud.

4. Other Features

A directory of advertisers may be created by the operator of the advertising system or portal in which the advertisers may be divided into categories and geographies for use.

The functionality of the advertising system may be supported by the use of one or more of the following: an automated tool for building ads (e.g., an ad building module), natural search optimization, a keyword engine, a bid manager module, reporting functions, and an automated or self-cataloging of websites and ads into a directory.

Additional functions that may be used with the advertising system include, for example, the following: credit card processing through a merchant account, and the dynamic assignment and data collection of a block of toll-free phone numbers for the system to optionally assign to advertisers on an as-needed basis for running and tracking pay-per-call campaigns.

The advertising system desirably may provide one or more of the following features, depending on the particular implementation of the advertising system selected for use:
1. Advertisers are able to create an account online and, for example, log into the web portal with a username and password. The site is desirably able to accommodate thousands of accounts, and to facilitate customer prepayment of ad budgets.
2. The site enables an advertiser to add funds to its account via major credit cards and to track its account activity.
3. The site generates and sends (e.g., via email) to each advertiser monthly invoices and/or account statements, and/or other documents germane to the account status.
4. The site accommodates the use of a coupon or promotional code to support outbound marketing campaigns.
5. The site may include an ad building module (sometimes referred to herein as “ad builder”), which allows advertisers to identify a landing page for the newly-created ad. The landing page may be provided, for example, by creating a new webpage or by specifying an existing URL. Pages that are created may be hosted on the area code local sites network, discussed below.
6. The ad building module may be designed to accommodate automated, template-based, website building and hosting (e.g., including URL registration for the advertiser or the dynamic assignment of an existing URL controlled by the operator of the advertising system).
7. A marketing campaign management dashboard (i.e., a user interface for interacting with the advertiser) that allows an advertiser to manage its ads, campaigns, reporting, user accounts, and budgets.
8. The advertising system may track the number of ads and campaigns being implemented per advertiser and accommodate pricing flexibility based on volume. This pricing may be automatically controlled by the advertising system according to certain volume levels and may be adjustable through an administrator interface (or dashboard interface) to the operator of the advertising system.
9. The administrator interface may use a password-controlled interface which allows authorized personnel to manage advertiser accounts, set and adjust promotional details for coupons/promo codes, and set standard volume discount rates.
10. The advertiser may be guided by the advertising system through the process of categorizing its business, identifying geographic targets for its advertising, and entering keywords.
11. The advertiser may select the search engines and/or other marketing channels for which its ad will be marketed with (e.g., Google, Yahoo!, and MSN search engines).
12. A keyword engine may be incorporated into the advertising system in such a manner as to be able to provide keyword suggestions for an advertiser based on its input and its related industry data.
13. The keyword engine may provide data for use in providing detailed reports to the advertiser. Information may be provided on past performance, estimated future performance, pricing, and other aspects of keywords.
14. A bid manager may manage existing or automatically create and manage accounts for the advertiser on its selected search engines, submit ads to the search engines that were created by the advertiser, and manage the advertiser's specified maximum cost per click bids on the selected keywords. There preferably is no advertiser visibility to the bid manager.
15. A reporting interface may allow the advertiser to select from available report formats and delivery methods.
16. The advertising system may automatically identify those advertisers with regularly-increasing budgets or activity and automatically report that information to the operator of the advertising system (e.g., for evaluation as a potential customer for additional online or personal services).
17. The advertiser may be presented the option of choosing various modes of marketing, including but not limited to number of impressions, pay-per-click, and pay-per-call models.
18. Each advertiser's ad page may be published on the area code local sites that correspond to the geographical targets or regions selected by the advertiser for the ads.
19. A demo of how an online campaign may be implemented, showing various channels of distribution and explaining some differences between directory listings, search engine ads, and banner ads, may be presented to the advertiser as a help guide.

Examples of products that may be sold to advertisers using the advertising system may include, but are not limited to, the following:

| Product | Cost Model | Timeframe |
|---|---|---|
| Directory Listing | Free. | Indefinite. |
| Business name, address, and | | |
| phone number. | | |
| Enhanced Directory Listing Ad | Performance fee when | Duration of |
| Uses coupon. | customers purchase | campaign. |
| | goods/services with | |
| | offer in coupon. | |
| Pay-Per-Click Search Engine Ad | Advertiser funds an | Number of |
| Keywords, Tagline, URL. | estimated budget | clicks to |
| Advertiser sets total budget, | account for next 30 | exhaust |
| keywords, and maximum number | days. | budget. |
| of bids. | | |
| Flat Fee Search Engine Ad | Flat monthly rate. | Month-to- |
| Keywords, Tagline, URL. | The advertising system | month or |
| Advertiser selects a flat monthly | may automatically | annual |
| rate for a minimum guaranteed | optimize the bidding | contract. |
| number of clicks (e.g., could be up | process to provide a | |
| to three tiers). Advertising system | targeted number of | |
| may manage the process of | clicks for a given | |
| delivering the targeted number of | funding provided by | |
| clicks. | the advertiser. | |
| Pay-Per-Call Search Engine Ad | Advertiser funds an | Estimated |
| Keywords, Tagline, Phone Number | estimated budget | number of |
| (provided by operator of portal). | account for next 30 | calls to |
| Advertiser sets budget at fixed rate | days. | exhaust |
| per call. | The advertising system | monthly |
| | may automatically | budget. |
| | optimize the bid | |
| | management. | |

Other embodiments of the advertising system may, for example, support co-branding of the system with other commercial entities that partner with the operator of the advertising system, and may use bi-directional application program interfaces (APIs) for receiving and distributing ads. The advertising system may also be used for providing a tracking-service only product to, for example, an application service provider (ASP) that reports tracking information regarding an SME's website. Also, blog content may be included and optimized for natural search. In addition, domain registration and/or web hosting for advertisers may be incorporated into the advertising system.

Product Feed Technology

1. Shopping Feed Aggregator

Comparison shopping websites often act as online aggregators of merchandise to allow consumers to compare similar products and then choose merchants to supply those products. XML feeds (which enables pages deep within a site, such as a product page four levels below the homepage, to be indexed rapidly) may be used to drive consumers directly to an advertiser's site to make a purchase or to capture orders on an advertiser's behalf. In the latter case, the advertising system may process the consumer's payment and place the money into the advertiser's online account.

Shopping feeds may offer consumers the benefit of comparison shopping without the hassle of waiting in lines. Supplying XML feeds to comparison sites may also increase the online marketing reach to consumers, connect with more-qualified customers, and return detailed product descriptions in a more timely fashion.

Search engine marketing techniques may be used to deliver measurable results from shopping feeds. A shopping feed aggregator may be used to optimize the search feeds across the various comparison sites and to maximize ROI. The shopping feed aggregator in one embodiment comprises the following elements:
Custom file submission: Advertisers submit a data dump (e.g., in CSV format). This file contains basic information that the advertising system customizes, formats, and submits to each shopping portal.
Tracking: After the product information is received, the advertising system implements, for example, a background pixel to track the number of conversions.
Optimization: NSO methods may be used manually or automatically to optimize feeds according to consumer behavior and other results. If a particular product receives several clicks, but no or reduced sales, the product description in an ad created using the advertising system may be modified manually and/or automatically. The ad's performance may then be monitored and compared to the performance of the prior version of the ad.
Analysis and Reporting: Results across the shopping sites may be analyzed via the advertising system's tracking features. Detailed reports may be produced based on this analysis and then supplied to advertisers having an account on the advertising system.
   2. Yahoo! Search Submit Service

The Yahoo! search submit program (Yahoo! is a trademark of Yahoo) may enhance visibility by returning a search result that is included in the natural search results, but sold to an advertiser on a pay-per-click basis. Other search services also may provide similar submit programs. The search submit service may offer several benefits for advertisers:
Guaranteed results in the Yahoo! search index.
Inclusion of web pages that might otherwise be excluded.
Control over listings and descriptions.
Choice of pages for inclusion in the index.
Immediate visibility.
Ability to refresh content within 48 hours.
Quantifiable results.

The Yahoo! service requests that marketers follow a step-by-step process in which they submit XML feeds of their URLs. The results are included in the index that powers algorithmic search results. Although these search results are essentially being purchased, the same basic algorithms are used to rank all content, paid and unpaid. Therefore, even though inclusion in the Yahoo! search index is assured, the ranking and placement of an ad are not guaranteed.

The XML or other search feeds may be optimized for a search submit program to aid the information in appearing more relevant to searchers, and thereby increasing qualified traffic and conversions.

Paid Search Platform

In an optional embodiment, a paid search media campaign may be managed with the advertising system. The bid manager module preferably is periodically servicing the advertisers' paid media campaigns to seek competitive results. The rules-based/intelligent-logic bidding system of the bid manager may monitor keywords and optimize bidding based on rules that are set to meet detailed business goals and objectives (e.g., as specified by an advertiser in the advertising system). The rules-based solution may be built on individual keywords or keyword grouping. In addition, rules may be prioritized for increased effectiveness.

One or more of the following features may be included in the paid search platform:
Largest Gap: Moves keyword listings to the largest bid gap within a specified set of positions.
Max CPC: Sets maximum cost-per-click.
Bid Position: Selects desired listing position.
Cost-Per-Action: Changes a keyword bid based upon past cost-per-action.
ROAS Bid Strategy: Changes a keyword bid based on return on advertising spending (ROAS) statistics from tracking done by the advertising system.
Day parting: Plots performance versus time and may detect patterns that suggest strategic bidding behavior.

Each pay-per-click search engine typically has different constraints. The bid manager in the advertising system may be customized for various search engine environments, handling as many keywords as allowed by each engine, to assist in data transfers with reduced errors.

Area Code Local

As mentioned above, each advertiser's ad page may be published on the area code local sites that correspond to the geographical targets or regions selected by the advertiser for the ads. The area code local sites may optionally contain other content such as, for example, weather, news, and business reviews.

The area code local sites may act as one of the marketing channels for the advertising campaigns created in the advertising system (e.g., the i2a.com site). These sites may provide online consumers with search results specific to the consumer's location or marketing area. These sites may use the domain names www.NNNLocal.com, where NNN represents a telephone area code (e.g., www.212Local.com). These sites may also be further localized by presenting content of local relevance (e.g., weather, news, etc.) through, for example, RSS feeds, encouraging online consumers to customize and use the sites regularly.

By aggregating and posting content from multiple advertisers on an area code local site, the advertising system is expected to be able to increase the visibility of the site to search engines (as well as other forms of online visibility) as compared to a non-aggregated approach. It is believed that this aggregation will improve the relevance of the area code local site to a consumer's online natural search for products or services in a given geographical region.

The design of the area code local sites may incorporate one or more of the following features:
All banner and skyscraper ad impressions may be tracked. All clicks on ads may be tracked.
Area code local sites may present categorized ads from the advertising system that are targeted for a specific area code.
Area code local sites may be comprised of business listings provided by clients, from a published list of existing businesses, or a combination thereof.
   Advertising System Architecture

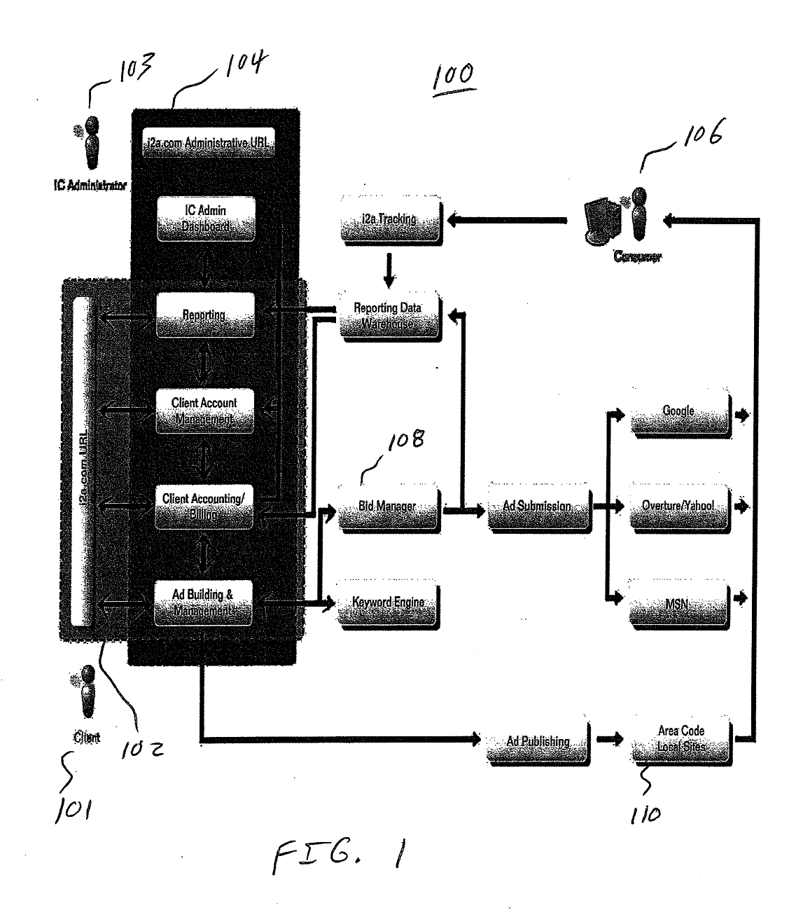

FIG. 1 is a functional block diagram illustrating an architecture for advertising system 100. Advertisers 101 access a URL that provides a portal to system 100. The extent of the advertiser's access is indicated by boundary 102.

The operator or administrator 103 of system 100 has access as indicated by boundary 104. Consumer or customer 106 views ads on various online channels. The ads are created by advertiser 101 on system 100. One of these online channels is one or more of area code local sites 110. System 100 includes various software modules such as, for example, bid manager 108 (as are discussed further herein).

Area Code Local Architecture

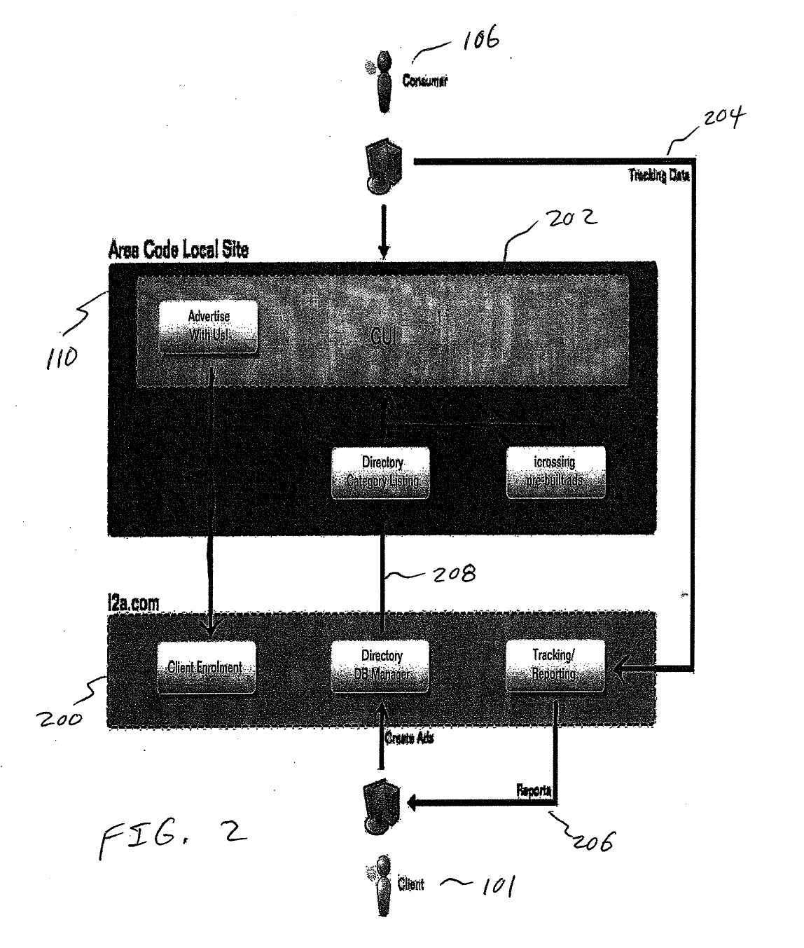

FIG. 2 is a functional block diagram illustrating an architecture for an area code local site 110 coupled to advertising system 200. Site 110 provides a web page interface 202 to consumers 106.

Tracking data 204 (corresponding to ads created by advertiser 101) from a client computer or device operated by consumer 106 is transmitted to tracking and reporting modules in system 200. Reports 206 are transmitted to advertiser 101.

Area code local site 110 is in communication with advertising system 200 over communications link 208, which may be, for example, an internet communications path.

Advertiser Functional Process Flow

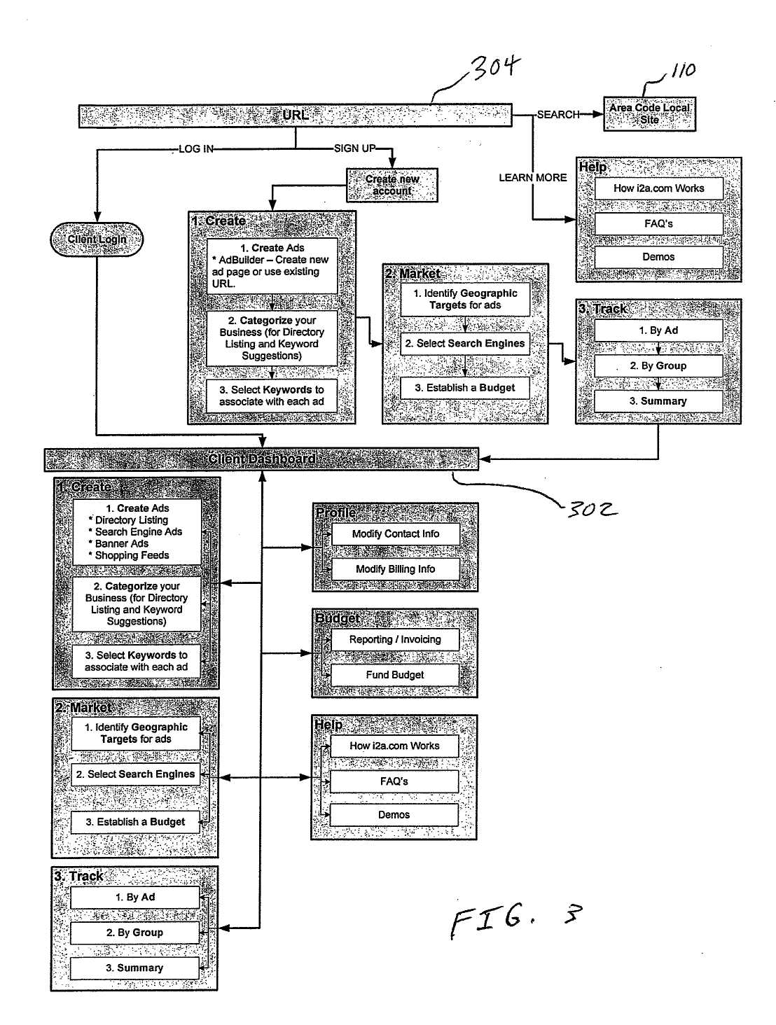

FIG. 3 illustrates the functional operational flow of the advertising system 100 (see FIG. 1) from the user perspective of advertiser 101. Advertiser 101 may be guided through the set-up steps of create, market, and track (e.g., after signing up with an account).

Client dashboard 302 is an interface for advertiser 101 to access the various functions of system 100. URL 304 is accessed to provide internet access to system 100.

System Implementation

The advertising system generally may be implemented using conventional hardware and network communication components and software programming techniques and languages. Examples of systems and methods that may be used with the advertising system described above are described in U.S. Patent Application Publication No. US 2005/0149396 A1 (titled ONLINE ADVERTISING SYSTEM AND METHOD by Horowitz et al. and published Jul. 7, 2005) and U.S. Patent Application Publication No. US 2005/0216335 A1 (titled SYSTEM AND METHOD FOR PROVIDING ON-LINE USER-ASSISTED WEB-BASED ADVERTISING by Fikes et al. and published Sep. 29, 2005), each of which is incorporated herein by reference.

The advertising system may run in a secure data center and may be provided as a web service to advertisers. The advertising system may, for example, be developed using a distributed, component-based architecture that can be scaled to accommodate a large number of advertiser sessions per day.

The software of the advertising system may be executed on one or more servers. The servers may communicate over a communication network with client devices such as, for example, a personal computer or PDA.

The communication networks may be, for example, the internet, a mobile phone network, or a local or wide area network. An application program, for example an internet browser or another application to provide a graphical or other user interface to an advertiser, may run on a client device and provide access by the advertiser to the advertising system server(s). An account on the server may be activated, for example, using logon information provided by the advertiser.

The advertising system server may execute various modules of software, which was described in more detail above. Information regarding advertisers may be stored in an advertiser account database, which is accessible by the advertising system server. The software modules that may be executed by the advertising system may, for example, be distributed across multiple servers.

The bid manager may be a rules-based engine that uses rules previously defined, for example, by the administrator of the advertising system or another entity having a business or other relationship to the administrator. The rules used by engine may optionally also include information defined by third parties and/or the advertisers. The rules used by the bid manager to generate one or more offers to search engines may include, for example, a large number of various mathematical, logical, or other functions that use data associated with the advertiser as operands.

### CONCLUSION

By the foregoing description, an improved advertising system and method have been described. The improved system and method may be substantially or completely web-based such that the advertiser user may access the advertising system server to manage ads from almost any computer (e.g., any network device providing, for example, internet browsing capabilities).

It is expected that advertisers without significant or any experience managing online ads may be able to open an account on the advertising system to create optimized ads and paid search campaigns across multiple search engines and other marketing outlets to drive traffic to a specific offer. Other advantages of the advertising system and method may include one or more of the following depending on the particular embodiment used:
Distribution of ads to partner networks via a advertiser self-service web portal.
Search engine advertising on multiple search engines.
Ad content is automatically optimized for top placement in natural search results.
A keyword generator creates more highly targeted ad content.
Locally-targeted ads within a larger publication network.
Track performance 24 hours a day.
Pay-per-click or pay-per-call payment models.
Guaranteed visitor program through specification of fixed ad budgets.
Ability to dynamically update ads as offers change.
Ad building module allows companies with or without a web presence to more easily promote themselves online with coupons and offers.
Bid manager module simplifies the budgeting and bidding process to allow advertisers to get better prices from the search engines for their pay-per-click or pay-per-call campaigns. Advertisers are able to implement a campaign using a fixed campaign budget (e.g., fixed dollars per time period).
Ad tracking to deliver real-time reports to advertisers that measure search engine performance, keyword analysis, and conversion tracking.
Automated use of online partnerships to leverage economies of scale and obtain more favorable rates for advertisers.
Rules-based bid manager module.
Automated performance data feeds for multiple search engines and directories.

The foregoing description of specific embodiments reveals the general nature of the disclosure sufficiently that others can, by applying current knowledge, readily modify and/or adapt it for various applications without departing from the generic concept. Therefore, such adaptations and modifications are within the meaning and range of equivalents of the disclosed embodiments. The phraseology or terminology employed herein is for the purpose of description and not of limitation.

What is claimed is:

1. An online advertising method comprising:
creating an online advertisement using a web portal;
marketing the advertisement online, wherein the marketing comprises selecting a marketing strategy using the web portal; and
tracking online activity associated with the advertisement.

2. The method of claim 1 further comprising providing payment using the web portal for the selected marketing strategy.

3. The method of claim 1 wherein the online advertisement includes one or more offers; and the tracking of online activity comprises tracking action in response to the one or more offers.

4. The method of claim 1 wherein the tracking of online activity is done through the web portal.

5. A system to provide an online marketing distribution network comprising:
a plurality of websites each associated with a geographic region, wherein each of the plurality of websites comprises one or more advertisements; and
wherein the one or more advertisements are selected for placement on a specific one of the plurality of websites based on a geographic correspondence of the one or more advertisements to the geographic region associated with the specific website.

6. The system of claim 5 wherein each geographic region corresponds to a telephone area code.

7. The system of claim 5 wherein the one or more advertisements describe products offered for sale in a physical store, and the geographic correspondence is the location of the physical graphic region associated with the specific website.
